(19) United States
(12) Patent Application Publication
(10) Pub. No.: US 2023/0069347 A1
(43) Pub. Date: Mar. 2, 2023

(54) DEVICE, METHOD, AND SYSTEM FOR CONCEPT DRIFT DETECTION

(71) Applicant: Hitachi, Ltd., Tokyo (JP)

(72) Inventors: Jana Backhus, Tokyo (JP); Mineyoshi Masuda, Tokyo (JP)

(73) Assignee: Hitachi, Ltd., Tokyo (JP)

(21) Appl. No.: 17/697,067

(22) Filed: Mar. 17, 2022

(30) Foreign Application Priority Data
Aug. 31, 2021 (JP) 2021-140828

(51) Int. Cl. G06N 5/04; G06N 20/00

(52) U.S. Cl. CPC G06N 5/04; G06N 20/00

(57) ABSTRACT

Aspects relate to determining the presence or absence of concept drift in seasonal time series data. A concept drift detection device including a data input unit for receiving a time series data set that includes a set of past time series data and a set of current time series data, a baseline model generation unit for generating a baseline model based on a subset of the set of past time series data, a feature extraction unit for extracting a set of past data features, a set of baseline data features, and a set of current data features, a distance calculation unit for calculating a baseline distance and a current distance, and a concept drift detection unit for determining, based on a baseline statistic and the current distance, presence or absence of concept drift between the set of current time series data and the set of past time series data.

### CROSS-REFERENCE TO RELATED APPLICATIONS

The present application claims priority to Japanese Patent Application No. 2021-140828, filed August 31^{st}, 2021. The contents of this application are incorporated herein by reference in their entirety.

### BACKGROUND OF THE INVENTION

The present disclosure generally relates to concept drift detection, and more particularly relates to detecting concept drift in seasonal time series data.

### SUMMARY OF THE INVENTION

In recent years, with the increasing digitalization in a wide variety of business areas, leveraging digital data to generate insights has become increasingly important to business operations. Artificial intelligence (AI) and machine learning (ML) technologies are examples of tools that can be used for data analysis and insight generation.

AI for Information Technology (IT) operations (AIOps) is one industry trend that supports the IT system operation management efforts of human operators by utilizing ML methods and data analysis of IT system data. AIOps solutions aim to reduce the total cost of ownership (TCO) and operation expenses (OpEx) through the utilization of AI, while maintaining high reliability, availability, and security of the IT system environment’s operation.

Some AIOps solutions relate to utilizing ML trained predictive models to make predictions regarding future outcomes. These predictive models are generally trained on past data, and subsequently used to generate predictions based on a given input data set. Such predictive models have a wide range of applications, including health care, risk evaluation, failure prediction, growth forecasting, and the like.

Predictive models, however, can be susceptible to concept drift. Generally, concept drift refers to a phenomenon in which the statistic properties of the target variable that the predictive model is trying to predict change over time in unforeseen ways. This negatively impacts the accuracy of the predictive model as the statistical properties of the target variable grow further apart from the data on which the predictive model was originally trained. Detecting and mitigating concept drift is important for maintaining highly accurate predictive models.

Conventionally, methods for detecting concept drift have been proposed. As an example, Cavalcante et al. (Non-Patent Document 1; CAVALCANTE, R, MINKU, LL & OLIVEIRA, A 2016, FEDD: Feature Extraction for Explicit Concept Drift Detection in Time Series, in Proceedings of the 2016 IEEE International Joint Conference on Neural Networks (IJCNN). IEEE Xplore, Vancouver, Canada, pp. 740-747. https://doi.org/10.1109/IJCNN.2016.7727274) disclose “A time series is a sequence of observations collected over fixed sampling intervals. Several real-world dynamic processes can be modeled as a time series, such as stock price movements, exchange rates, temperatures, among others. As a special kind of data stream, a time series may present concept drift, which affects negatively time series analysis and forecasting. Explicit drift detection methods based on monitoring the time series features may provide a better understanding of how concepts evolve over time than methods based on monitoring the forecasting error of a base predictor. In this paper, we propose an online explicit drift detection method that identifies concept drifts in time series by monitoring time series features, called Feature Extraction for Explicit Concept Drift Detection (FEDD). Computational experiments showed that FEDD performed better than error-based approaches in several linear and nonlinear artificial time series with abrupt and gradual concept drifts.”

Non-Patent Document 1 discloses a technique for detecting concept drift in stationary time series data by calculating a distance between statistical features of past and current time series data. A single-value drift detection threshold is calculated based on an exponentially weighted moving average control chart with an already known baseline mean and standard deviation distance.

The technique disclosed in Non-Patent Document 1, however, while applicable for concept drift detection in stationary time series data with an independent and identical distribution, is not applicable to non-stationary, seasonal time series data (for example, IT system performance data). More particularly, Non-Patent Document 1 describes using a single-value drift detection threshold for concept drift detection, but such a single-value drift detection threshold is not effective for accurately determining concept drift in seasonal time series data that requires separate baseline statistics for each of a number of seasonal time periods.

Accordingly, it is an object of the present disclosure to provide a device, method, and system for concept drift detection that is capable of determining the presence or absence of concept drift in seasonal time series data.

One representative example of the present disclosure relates to a concept drift detection device for detecting concept drift in a time series data set, the concept drift detection device including a data input unit configured to receive a time series data set that includes a set of past time series data relating to a first time period and a set of current time series data relating to a second time period subsequent to the first time period; a baseline model generation unit configured to generate a baseline model based on a subset of the set of past time series data; a feature extraction unit configured to divide the set of past time series data into a set of past windows, divide the set of current time series data into a set of current windows, and divide a set of baseline data created by the baseline model into a set of baseline windows, and calculate a set of baseline data features from the set of baseline windows, calculate a set of past data features from the set of past windows, and calculate a set of current data features from the set of current windows; a distance calculation unit configured to calculate a baseline distance between a subset of the set of past data features and a subset of the baseline data features that relate to a corresponding time frame, and calculate a current distance between a subset of the set of current data features and a subset of the baseline data features that relate to a corresponding time frame; and a concept drift detection unit configured to calculate, based on the baseline distance, a baseline statistic that indicates a reference for determining concept drift, and determine, based on the baseline statistic and the current distance, presence or absence of concept drift between the set of current time series data and the set of past time series data.

According to the present disclosure it is possible to provide a device, method, and system for concept drift detection that is capable of determining the presence or absence of concept drift in seasonal time series data.

Problems, configurations, and effects other than those described above will be made clear by the following description in the embodiments for carrying out the invention.

### BRIEF DESCRIPTION OF THE DRAWINGS

FIG. 1 is a block diagram illustrating an example computing architecture for executing the embodiments of the present disclosure.

FIG. 2 is a diagram illustrating an example configuration of a concept drift detection system according to embodiments of the present disclosure.

FIG. 3 is a graph illustrating an example of concept drift in time series data, according to the embodiments of the present disclosure

FIG. 4 illustrates an example of a set of seasonal time series data according to the embodiments of the present disclosure.

FIG. 5 is a flowchart illustrating an example of a concept drift detection process according to the present disclosure.

FIG. 6 is a block diagram illustrating an example of the flow of data within the concept drift detection device 250 according to the present disclosure.

### DETAILED DESCRIPTION

As described herein, aspects of the present disclosure relate to detecting concept drift in seasonal time series data. Concept drift detection is one important research topic related to performance monitoring of ML-trained predictive models. Many ML-trained models assume that the input-output-relationship observed for the target data is static, and therefore remains the same for all future data. If this assumption fails for some reason, it can be said that concept drift has occurred. Here, the term “concept” refers to the target variable or quantity to be predicted. Deviation from this concept, that is, concept drift, can lead to degrading performance of the ML-trained predictive models. In general, to detect concept drift, it is necessary to compare the current concept to some baseline concept, and subsequently detect concept drift based on the performance error of the predictive model, or the features of the real data distribution. If the comparison of the current and baseline concepts differ by more than a threshold value, it is determined that concept drift has occurred.

One scenario in which the detection of concept drift is important relates to using ML-trained predictive models to analyze IT system data. As the system configuration and workload constellations of IT systems, such as data storage facilities, frequently change, these configuration changes can impact the input-output relationship of the observed IT system data and give rise to concept drift, negatively affecting the performance of the ML-trained predictive models. In order to reduce operation expenses and total cost of ownership, it is desirable to conduct performance monitoring and updating of these ML-trained predicted models in an automatic fashion.

Accordingly, aspects of the disclosure relate to a device, method, and system for concept drift detection that is capable of determining the presence or absence of concept drift in seasonal time series data. As will be described later in detail, aspects of the disclosure relate to generating a separate baseline statistic for each seasonal time period of a set of time series data. Additional aspects relate to using a distance smoothing operation to smooth feature distances to reduce outliers. Further aspects relate to dividing time series data into rolling time windows to obtain statistical features for shorter seasonal time frames.

Hereinafter, embodiments of the present invention will be described with reference to the Figures. It should be noted that the embodiments described herein are not intended to limit the invention according to the claims, and it is to be understood that each of the elements and combinations thereof described with respect to the embodiments are not strictly necessary to implement the aspects of the present invention.

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter.

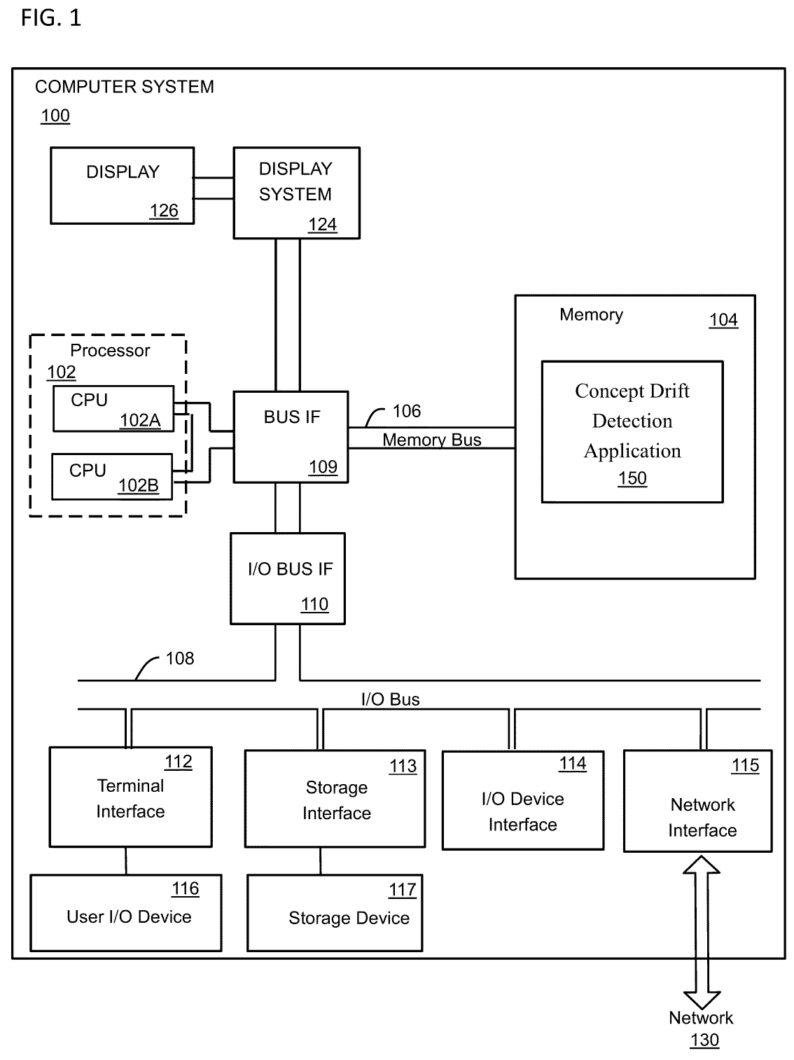

Turning now to the Figures, FIG. 1 depicts a high-level block diagram of a computer system 100 for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal interface 112, a storage interface 113, an I/O (Input/Output) device interface 114, and a network interface 115, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a concept drift detection application 150. In embodiments, the concept drift detection application 150 may include instructions or statements that execute on the processor 102 or instructions or statements that are interpreted by instructions or statements that execute on the processor 102 to carry out the functions as further described below.

In certain embodiments, the concept drift detection application 150 is implemented in hardware via semiconductor devices, chips, logical gates, circuits, circuit cards, and/or other physical hardware devices in lieu of, or in addition to, a processor-based system. In embodiments, the concept drift detection application 150 may include data in addition to instructions or statements. In certain embodiments, a camera, sensor, or other data input device (not shown) may be provided in direct communication with the bus interface unit 109, the processor 102, or other hardware of the computer system 100. In such a configuration, the need for the processor 102 to access the memory 104 and the concept drift detection application 150 may be reduced.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 113, 114, and 115, which are also known as I/O processors (IOPs) or I/O adapters (IOAs), through the I/O bus 108. The display system 124 may include a display controller, a display memory, or both. The display controller may provide video, audio, or both types of data to a display device 126. Further, the computer system 100 may include one or more sensors or other devices configured to collect and provide data to the processor 102.

As examples, the computer system 100 may include biometric sensors (e.g., to collect heart rate data, stress level data), environmental sensors (e.g., to collect humidity data, temperature data, pressure data), motion sensors (e.g., to collect acceleration data, movement data), or the like. Other types of sensors are also possible. The display memory may be a dedicated memory for buffering video data. The display system 124 may be coupled with a display device 126, such as a standalone display screen, computer monitor, television, or a tablet or handheld device display.

In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 116, which may include user output devices (such as a video display device, speaker, and/or television set) and user input devices (such as a keyboard, mouse, keypad, touchpad, trackball, buttons, light pen, or other pointing device). A user may manipulate the user input devices using a user interface in order to provide input data and commands to the user I/O device 116 and the computer system 100, and may receive output data via the user output devices. For example, a user interface may be presented via the user I/O device 116, such as displayed on a display device, played via a speaker, or printed via a printer.

The storage interface 113 supports the attachment of one or more disk drives or direct access storage devices 117 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 117 may be implemented via any type of secondary storage device. The contents of the memory 104, or any portion thereof, may be stored to and retrieved from the storage device 117 as needed. The I/O device interface 114 provides an interface to any of various other I/O devices or devices of other types, such as printers or fax machines. The network interface 115 provides one or more communication paths from the computer system 100 to other digital devices and computer systems; these communication paths may include, for example, one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

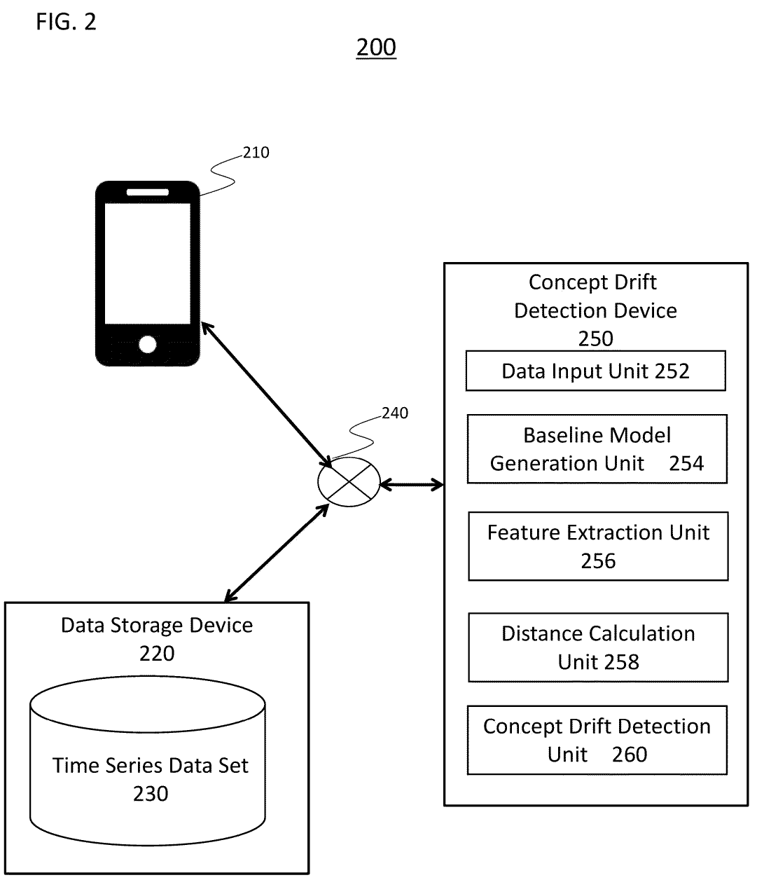

Next, an example configuration of a concept drift detection system according to embodiments of the present disclosure will be described with reference to FIG. 2.

FIG. 2 is a diagram illustrating an example configuration of a concept drift detection system 200 according to embodiments of the present disclosure. As illustrated in FIG. 2, the concept drift detection system 200 includes a client device 210, a data storage device 220 that stores a time series data set 230, a communication network 240, and a concept drift detection device 250. The client device 210, the data storage device 220, and the concept drift detection device 250 may be communicably connected via the communication network 240. Here, the communication network 240 may include the Internet, a Local Area Network (LAN) connection, a Metropolitan Area Network (MAN) connection, a Wide Area Network (WAN) connection, or the like.

The client device 210 is a device configured to transmit and receive information with respect to the concept drift detection device 250 and/or the data storage device 220. The client device 210 may be used by an owner or administrator of the data storage device 220 and the time series data set 230 to transmit a concept drift detection request to the concept drift detection device 250 to initiate analysis of the time series data set 230. In embodiments, the client device 210 may include a personal computing device (e.g., a smart phone, a tablet, a smart watch, a laptop computer) or the like. The client device 210 may be configured to receive commands and instructions from a user via a user interface.

The data storage device 220 is a device configured to store and maintain the time series data set 230. In embodiments, the data storage device may include hard disk drives, random access memory (RAM), a read-only memory (ROM), an erasable programmable read-only memory (EPROM or Flash memory), a static random access memory (SRAM), or the like. In certain embodiments, the data storage device 220 may include a plurality of distributed cloud storage systems.

The time series data set 230 is the data that serves as the analysis target of the concept drift detection device 250. Here, the time series data set 230 refers to a collection of data points indexed in time order at successive equally spaced points in time. As examples, the time series data set 230 may include data related to weather observations, IT systems, economics, health care, or any other information that can be modeled in temporal order.

In embodiments, the time series data set 230 may include a set of past time series data relating to a first time period and a set of current time series data relating to a second time period subsequent to the first time period. Here, the first and second time periods may refer to any period of time, such as a year, a month, a week, a day, an hour, or the like.

The time series data set 230 may include internal structures and relationships between time series data points, such as autocorrelation, trends, or seasonality. It is desirable for these internal structures and relationships to be recognized and accounted for when training ML predictive models. More particularly, as will be described, herein, aspects of the present disclosure relate to cases in which the time series data set 230 is seasonal (e.g., seasonal) in nature. Here, seasonality refers to the presence of variations in the data that occur at specific regular intervals. Seasonality may be caused by a variety of factors, such as system configuration changes, weather, employee work schedules, or the like, and consists of periodic, repetitive, and generally regular and predictable patterns in the time series data set 230.

The concept drift detection device 250 is a device configured to analyze the time series data set 230 and determine the presence or absence of concept drift. For example, the concept drift detection device 250 may determine the existence of concept drift between the set of past time series data and the set of current time series data included in the time series data set 230. As illustrated in FIG. 2, the concept drift detection device 250 primarily includes a data input unit 252, a baseline model generation unit 254, a feature extraction unit 256, a distance calculation unit 258, and a concept drift detection unit 260. However, the present disclosure is not limited herein, and the concept drift detection device may include other functional units (e.g., a distance smoothing unit to be described later).

The data input unit 252 is a functional unit configured to receive the time series data set 230 from the data storage device 220. As described herein, the time series data set 230 may include a set of past time series data and a set of current time series data. In embodiments, the concept drift detection device 250 may receive transmission of the time series data set 230 via the communication network 240. In embodiments, the concept drift detection device 250 may be granted access to the data storage device 220 to perform analysis of the time series data set 230 without transmitting the time series data set 230 over the communication network 240.

The baseline model generation unit 254 is a functional unit configured to generate a baseline model based on a subset of the set of past time series data. Here, as an example, the baseline model may include a trained machine learning model configured to generate a predicted time series data set based on a current time series data set.

The feature extraction unit 256 is a functional unit configured to divide the set of past time series data into a set of past windows, divide the set of current time series data into a set of current windows, and divide the baseline model into a set of baseline windows, and subsequently calculate a set of baseline data features from the set of baseline windows, calculate a set of past data features from the set of past windows, and calculate a set of current data features from the set of current windows.

The distance calculation unit 258 is a functional unit configured to calculate a baseline distance between a subset of the set of past data features and a subset of the baseline data features that relate to a corresponding time frame, and calculate a current distance between a subset of the set of current data features and a subset of the baseline data features that relate to a corresponding time frame.

The concept drift detection unit 260 is a functional unit configured to calculate, based on the baseline distance, a baseline that indicates a reference for determining concept drift, and determine, based on the baseline and the current distance, presence or absence of concept drift between the set of current time series data and the set of past time series data.

The above described functional units of the concept drift detection device 250 may be implemented as software modules configured to be executed on a computer system (for example, software modules of the concept drift detection application 150 of the computer system 100 illustrated in FIG. 1). In other embodiments, the above described functional units of the concept drift detection device 250 may be implemented as dedicated hardware units.

It should be noted that, while FIG. 2 illustrates one example configuration of the concept drift detection system 200, the present disclosure is not limited thereto. For example, a configuration in which the concept drift detection device 250 and the data storage device 220 are integrated as a single hardware unit, or a configuration in which the client device 210, the data storage device 220, and the concept drift detection device 250 are all implemented in the same local area network are also possible.

By means of the concept drift detection system 200 illustrated in FIG. 2, it is possible to perform concept drift detection that is capable of determining the presence or absence of concept drift in seasonal time series data.

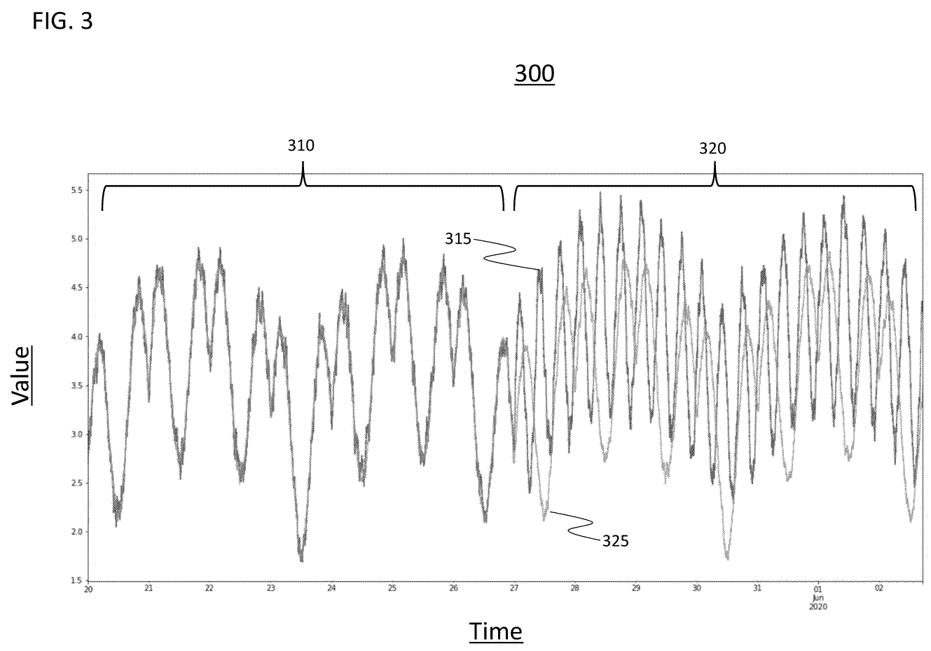

Next, an example of a graph illustrating concept drift will be described with respect to FIG. 3.

FIG. 3 is a graph 300 illustrating an example of concept drift in time series data, according to the embodiments of the present disclosure. Graph 300 illustrates the progression of both real values 315 and predicted values 325 of a particular target variable (e.g., a concept) with respect to time. As an example, the real values 315 may represent the actual measured I/O traffic load of a storage device and the predicted values 325 may illustrate the I/O traffic load of the storage device as predicted by a ML predictive model.

As illustrated in the graph 300, although the progression of the predicted values 325 closely corresponds with the progression of the real values 315 throughout the course of a first time period 310, the progression of the predicted values 325 diverges from the progression of the real values 315 during a second time period 320. Here, it can be said that concept drift has occurred in the real values 315, and as a result, the prediction accuracy of the ML prediction model has degraded. This concept drift may, for example, have arisen as a result of a change in the configuration of the storage device that impacted its I/O traffic load.

Accordingly, aspects of the present disclosure relate to detecting such concept drift in seasonal time series data, and updating the predictive model to facilitate predictive accuracy.

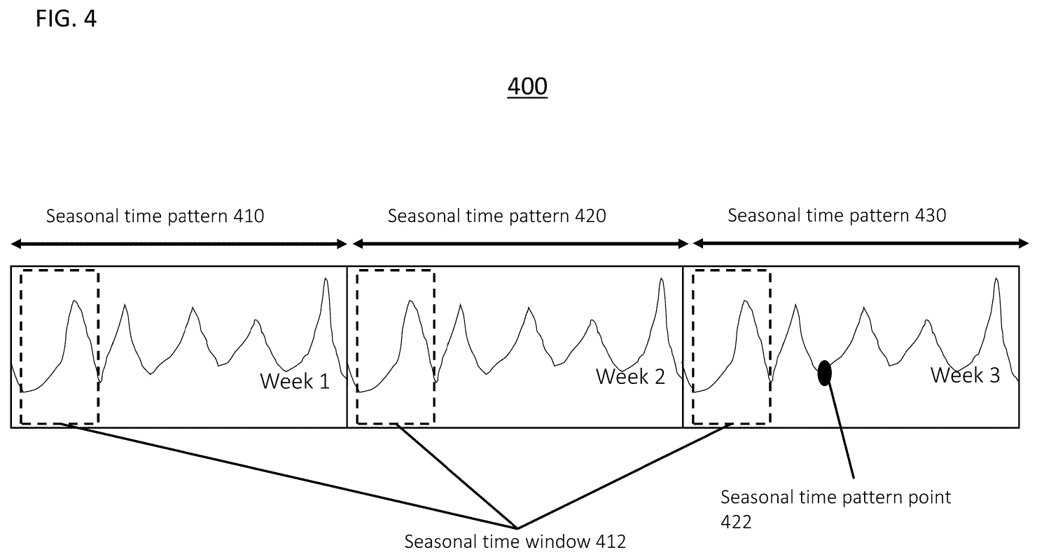

Next, an example of a set of seasonal time series data will be described with respect to FIG. 4.

As described here, aspects of the disclosure relate to detecting concept drift in seasonal time series data. Here, seasonality refers to the presence of variations in the data that occur at specific regular intervals. Seasonality may be caused by a variety of factors, such as system configuration changes, weather, or the like, and consists of periodic, repetitive, and generally regular and predictable patterns in the time series data set. Accounting for seasonality is desirable in order to facilitate the accuracy of predictive models that analyze time series data having seasonal characteristics.

FIG. 4 illustrates an example of a set of seasonal time series data 400 according to the embodiments of the present disclosure. As described herein, seasonal time series data naturally includes periodic, repetitive patterns of variation. Here, the periodic, repetitive patterns of variation present in seasonal time series data are referred to as seasonal time patterns. As an example, as illustrated in FIG. 4, the set of seasonal time series data 400 includes three seasonal time patterns 410, 420, 430. Each of the three seasonal time series pattern corresponds to a defined time period. As an example, as illustrated in FIG. 4, each of the three seasonal time series pattern may correspond to a defined time period of a week, although the present disclosure is not limited hereto, and the defined time period may be a second, minute, an hour, a day, multiple days, a year, or any other time period.

Further, each seasonal time pattern 410, 420, 430 includes one or more seasonal time windows 412. Here, a seasonal time window 412 refers to a series of consecutive seasonal time pattern points 422 that make up a portion of a seasonal time pattern 410, 420, 430. Each seasonal time window 412 in a particular seasonal time pattern 410, 420, 430 corresponds to a seasonal time window in the other seasonal time patterns of the set of seasonal time series data 400. As an example, in the case that each seasonal time pattern 410, 420, 430 represents a week, “Monday” may represent a seasonal time window 412 in each of the three seasonal time patterns 410, 420, 430.

A seasonal time pattern point 422 refers to a particular point within the progression of a seasonal time pattern 410, 420, 430, and corresponds to a particular time feature. Here, a time feature refers to a defined, repetitive point or period of time, and may include a second, minute, an hour, a day, a year, or any other time duration. A seasonal time pattern 410, 420, 430 may be defined in terms of seasonal time pattern points 422 corresponding to any suitable time feature. The time features for a particular seasonal time pattern 410, 420, 430 depend on the types of observed seasonality and the observed interval of the time series.

As an example, in the case that each seasonal time pattern 410, 420, 430 represents a week, each seasonal time pattern point 422 may correspond to a day of the week (in which case there are 7 seasonal time pattern points 422 per seasonal time pattern), an hour (in which case there are 168 time pattern points 422 per seasonal time pattern), a minute (in which case there are 10,080 time pattern points 422 per seasonal time pattern), or the like.

Two seasonal time pattern points 422 are considered equal when they have the same time feature values (each, same value on the vertical axis). Similarly, two seasonal time windows 412 are considered equal when the start and end seasonal time pattern points are equal.

One example of seasonality can be observed in the usage of computing resources of IT systems used in large-scale business environments. In this scenario, the seasonality present in a time series data set representing the usage of IT system computing resources is highly influenced by the working hours of users. For instance, the usage of computing resources of IT systems significantly increases during employee working hours (for example, Monday to Friday from 9 AM to 5 PM), and decreases outside of these time frames. Accordingly, the working hours of users give rise to both weekly seasonality and daily seasonality in a time series data set representing the use of IT system computing resources.

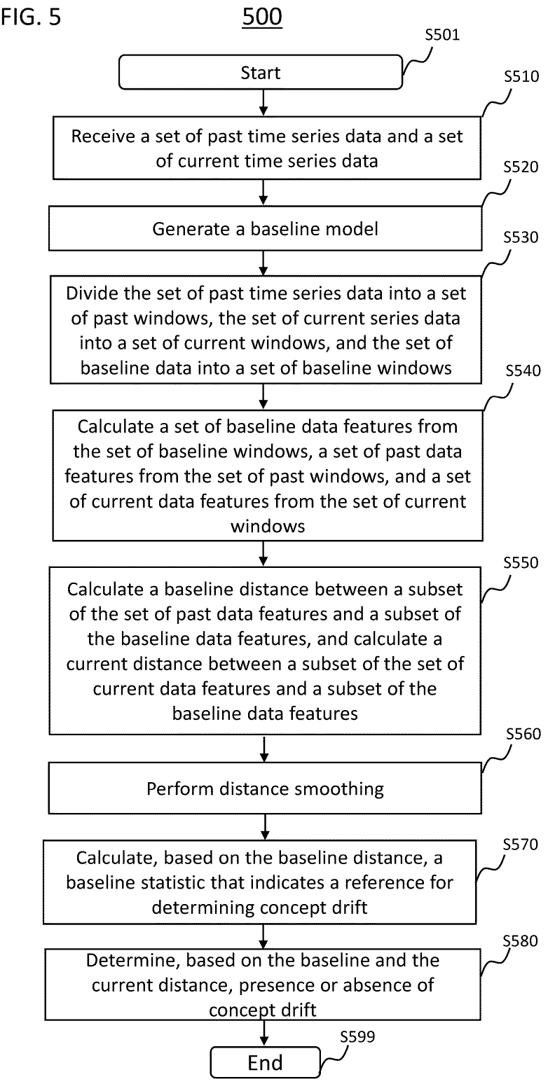

Next, an example of a concept drift detection process according to the present disclosure will be described with respect to FIG. 5.

FIG. 5 is a flowchart illustrating an example of a concept drift detection process 500 according to the present disclosure. The concept drift detection process 500 illustrates a method for detecting concept drift in seasonal time series data, and may be performed by the various functional units of the concept drift detection device according to the present disclosure (for example, the concept drift detection device 250 illustrated in FIG. 2). As illustrated in FIG. 5, the concept drift detection process may start at Step S501 and complete at Step S599.

First, at Step S510, the data input unit (for example, the data input unit 252 of the concept drift detection device 250) receives a time series data set that includes a set of past time series data (Xₚₐₛₜ) and a set of current time series data (X_{current}). Here, the time series data set may be transmitted to the data input unit of the concept drift detection device from a client device, or may be acquired from a local or distributed storage device accessible by the concept drift detection device. As described herein, the time series data set may include data related to weather observations, IT systems, economics, health care, or any other information that can be modeled in temporal order.

In embodiments, the time series data set may include a set of past time series data relating to a first time period and a set of current time series data relating to a second time period subsequent to the first time period. Here, the first and second time periods may refer to any period of time, such as a year, a month, a week, a day, an hour, or the like.

Next, at Step S520, the baseline model generation unit (for example, the baseline model generation unit 254 of the concept drift detection device 250) generates a baseline model based on a subset of the set of past time series data. The baseline model may be configured to process a subset of the set of past time series data to generate a set of baseline data. As will be described later, this baseline data is used for the creation of both a baseline distance and a current distance for evaluating the presence or absence of concept drift.

The baseline data generated by the baseline model may include a baseline seasonal pattern that provides one data value for each combination of seasonal features, or real past values where the seasonal time features are aligned with the compared real data (past or current).

The baseline model may be implemented in a variety of configurations. For instance, in embodiments, the baseline model may be implemented as a machine learning (ML) predictive model that is trained to detect seasonal patterns in time series data and predicts outputs. Here, in certain embodiments, in the training phase, the ML model may be trained based on seasonal time features, (e.g. minute, hour, day-of-week etc.). Next, in the inference phase, the ML model may be input with seasonal time features and output a seasonal time pattern. Further, in other embodiments, in the training phase, the ML model may be trained based on time series data. Next, in the inference phase, the ML model may generate a time series as an output based on the input data (e.g. recent past data of a time series). In this way, by using a ML model to output a predicted time series as baseline data, it becomes possible to determine the presence or absence of concept drift based on the performance error of the predictive model for past data with respect to current data (that is, comparing the prediction accuracy of the ML model for past data with respect to the prediction accuracy for current data, and determining the existence of concept drift based on this comparison).

Further, in certain embodiments, the set of past time series data may be processed without using a machine learning model. In such a case, the baseline model may be a statistical model configured to average the set of past time series data according to the seasonal time features of the data (that, is, calculate the mean for past data time series values of the set of past time series data at corresponding seasonal time pattern points), and output a seasonal time pattern. Further, in other embodiments, the baseline model may be configured to shift a set of past time series data and a set of current time series data by one or several seasonal time pattern lengths to the past (e.g., shift by N) before using it as a base of comparison with the real past and current data, and output a baseline data time series. In this way, by calculating the baseline data directly from the set of past time series data, it becomes possible to determine the presence or absence of concept drift based on the observed deviation between real data seasonal time pattern periods (that is, determine the size of the deviation between the past time series data and the current time series data with respect to the baseline data, and determine that concept drift exists if the deviation is larger for the current time series data).

As described herein, it is possible to use a variety of types of time series data as input, and the present disclosure is not limited to cases in which a trained ML predictive model is available. However, for ease of explanation, in the following, a case in which a trained machine learning predictive model is used as the baseline model will be described.

Next, at Step S530, the feature extraction unit (for example, the feature extraction unit 256 of the concept drift detection device 250) divides the set of past time series data into a set of past windows, divides the set of current time series data into a set of current windows, and divides the set of baseline data into a set of baseline windows. Here, dividing data into windows refers to splitting the past time series data, the current time series data, and the baseline data into segmented portions having a fixed length that is shorter than that of the seasonal time pattern of each respective data set. For instance, the feature extraction unit may divide the set of past time series data, the set of current series data, and the set of baseline data into rolling windows with a fixed time delta window length 1, where 1 is less than the length of a seasonal time pattern. Here, the windows may partially overlap with each other. For instance, a first window may have a window length from time 1 to 1, and a second window may have a window length from time 2 to 1+1. The amount by which the windows overlap may be freely configured. As another example, the first window may have a window length from time 1 to 1, and the second window may have a window length from time 10 to 1+10.

In this way, by splitting data into windows that are smaller in length than a seasonal time pattern, it becomes possible to detect smaller concept drift changes that occur only at certain seasonal time pattern points or time windows in seasonal time pattern.

Next, at Step S540, the feature extraction unit calculates a set of baseline data features from the set of baseline windows, calculates a set of past data features from the set of past windows, and calculates a set of current data features from the set of current windows. Here, calculating the set of baseline data features, the set of past data features, and the set of current data features may include extracting statistical features for each respective window. More particularly, the feature extraction unit may obtain a feature vector for each window from a first time point (i-1) to a second time point i of a time series with length M, where 1≤i≤M (or, alternatively, from a first time feature (j-1) to j of a seasonal time pattern with length N, where 1≤j≤N). The statistical features calculated here may include the mean, the standard deviation, the mediation, the variation, the interquartile range, the kurtosis, the skewness, the median absolute deviation, the maximum, the minimum, or the like.

In this way, feature vectors are calculated for each window of each of the three types of input data: that is, a set of past data features are directly calculated from the set of past windows, a set of baseline data features are calculated from baseline data output by the baseline model (either time series data or seasonal time pattern data), and a set of current data features are directly calculated from the set of current windows. In this way, one feature vector is calculated for each window, such that a set of feature vectors exist for a set of windows.

Next, at Step S550, the distance calculation unit (for example, the distance calculation unit 258 of the concept drift detection device 250) calculates a baseline distance between a subset of the set of past data features and a subset of the baseline data features that relate to a corresponding time frame, and calculates a current distance between a subset of the set of current data features and a subset of the baseline data features that relate to a corresponding time frame. More particularly, the distance calculation unit may calculate a baseline distance between a past data feature vector in the set of past data features and a baseline data feature vector in the set of baseline data features that relate to a corresponding time frame, and calculate the current distance between a current data feature vector in the set of current data features and a baseline data feature vector in the set of baseline data features that relate to a corresponding time frame.

Here, “data feature vectors that relate to a corresponding time frame” refer to data feature vectors that were collected for a substantially similar period of time (e.g., April 1^{st}, 2021 from 8 AM to 8 PM).

The baseline distance is a quantitative indication of the relative similarity between a past data feature vector and a baseline data feature vector. Similarly, the current distance is a quantitative indication of the relative similarity between a current data feature vector and a baseline data feature vector. In embodiments, the baseline distance and the current distance may be calculated using the following Equation.

$$d i s {t}_{c o s} \left(A , B\right) = 1 - \frac{A ⋅ B}{\left‖A\right‖ \left‖B\right‖} = 1 - \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

Here, A and B represent two different feature vectors. For instance, when calculating baseline distance, A may be a feature vector of a past data time window and B may be a feature vector of a baseline data time window, and when calculating current distance, A may be a feature vector of a current data time window and B may be a feature vector of a baseline data time window. In this way, the baseline distance can be calculated between the past and baseline data feature vectors, and the current distance can be calculated between the current and baseline data feature vectors. By calculating distance between feature vectors obtained from individual windows (e.g., as opposed to calculating distance between real data), it becomes possible to reduce error proneness to smaller drifts/misalignments within the time series.

It should be noted that, in cases where the baseline data feature vectors consist of only one seasonal time pattern period, the baseline data feature vectors are repetitively assigned based on the corresponding time features of the past or current data feature vectors. Additionally, the output of this step includes two time series of distances: the baseline distance time series for a baseline concept and the current distance time series for a current concept at each available time point i of the set of past time series data Xₚₐₛₜ and the set of current time series data X_{current}.

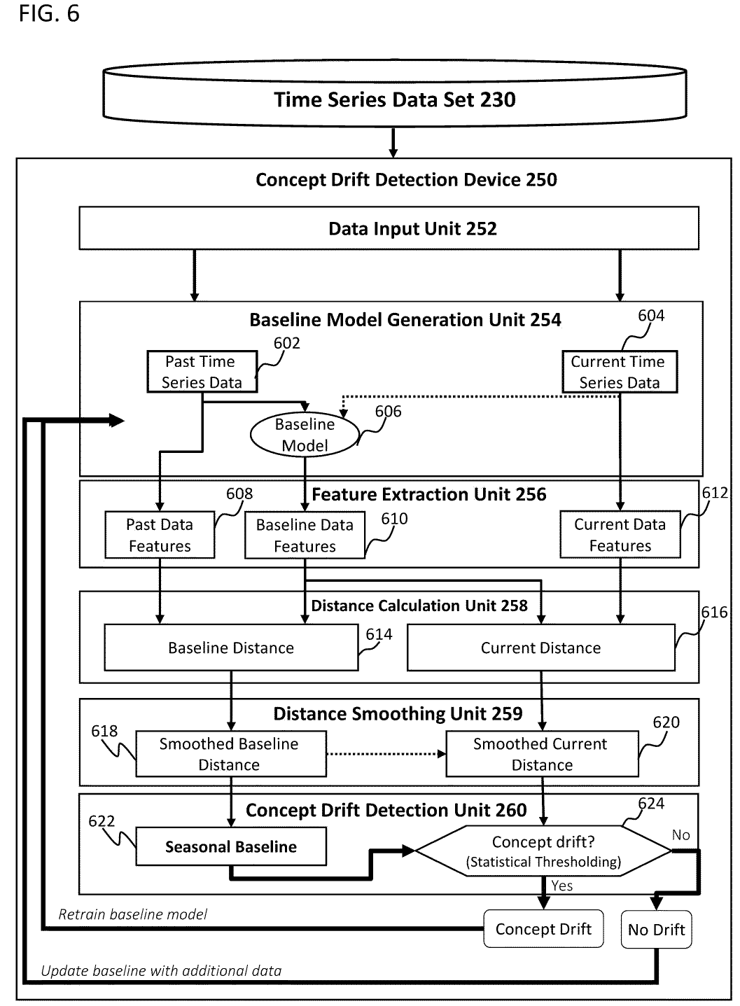

Next, at Step S560, the distance smoothing unit (for example, the distance smoothing unit 259 illustrated in FIG. 6) performs distance smoothing with respect to the baseline distance time series and the current distance time series obtained in Step S550. Here, the distance smoothing unit may perform distance smoothing with respect to each data point in the baseline distance time series and the current distance time series based on values close in time to that point (e.g., by emphasizing a certain weight on the most recent observed value). More particularly, the distance smoothing unit may apply an exponentially weighted moving average (EWM) and variance technique with respect to the baseline distance time series and the current distance time series. The distance smoothing unit may calculate the EWM average (mean) using the following equation.

$${μ}_{i} = \left(1 - λ\right) {μ}_{i - 1} + λ {x}_{i} ,$$

Additionally, the distance smoothing unit may calculate the EWM variance using the following equation.

$${σ}_{i}^{2} = {S}_{i} = \left(1 - λ\right) \left({S}_{i - 1} + λ {\left({x}_{i} - {μ}_{i - 1}\right)}^{2}\right)$$

Here, xᵢ is the current distance value at a given time point i referring to some time window, and the parameter 0≤λ≤1 represents the weight given to recent data compared to previous data. Also, when smoothing the current distance time series, the distance smoothing unit may use already smoothed values of the baseline distance time series as input to improve the smoothing effect for the first observed values (here, consideration of the correct time series feature alignment is necessary). In this way, a set of smoothed baseline distance data (EWM smoothed mean/variance) and a set of smoothed current distance data (EWM smoothed mean) can be obtained. By smoothing the baseline distance time series and current distance time series, it becomes possible to reduce noise, false positives, and false negatives in concept drift detection.

Next, at Step S570, the concept drift detection unit calculates a baseline statistic based on the baseline distance data (e.g., the smoothed baseline distance data obtained in Step S560). Here, the baseline statistic indicates a reference for determining concept drift. In embodiments, the baseline statistic may be a seasonal baseline that indicates a reference for determining concept drift for each of the set of seasonal time pattern points of the baseline distance data that belong to the same seasonal time feature (e.g. minute, hour, day-of-week). The concept drift detection unit may calculate the seasonal baseline by calculating the overall mean and standard deviation for each set of seasonal time pattern points in the baseline distance time series.

More particularly, the concept drift detection unit may calculate a seasonal baseline for each seasonal time feature j by averaging all the EWM-smoothed mean values µᵢ and variance values σ², where seasonal time pattern point i has time features j (e.g., i belongs to seasonⱼ). In this way, a single baseline mean and standard deviation value for each seasonal time feature j may be obtained. The seasonal time feature baseline mean µⱼ may be calculated using the following equation.

$${μ}_{j} = \frac{1}{\left|s e a s o {n}_{j}\right|} {\sum }_{i}^{s e a s o {n}_{j}} {μ}_{i}$$

The seasonal time feature baseline standard deviation σⱼ may be calculated using the following equation.

$${σ}_{j} = \sqrt{\frac{1}{\left|s e a s o {n}_{j}\right|} {\sum }_{i}^{s e a s o {n}_{j}} {σ}_{i}^{2} + \frac{1}{\left|s e a s o {n}_{j}\right| - 1} {\sum }_{i}^{s e a s o {n}_{j}} {\left({μ}_{i} - {μ}_{j}\right)}^{2}}$$

Next, at Step S580, the concept drift detection unit determines, based on the baseline statistic (e.g., the seasonal baseline) and the current distance data (e.g., the smoothed current distance data obtained in Step S560), presence or absence of concept drift between the set of current time series data and the set of past time series data. Here, the concept drift detection unit may use a statistical thresholding technique to calculate a seasonal threshold for each seasonal time feature with the seasonal mean and standard deviation indicated by the seasonal baseline calculated in Step S570, and subsequently determine whether or not concept drift exists for a seasonal time pattern point i of the EWM smoothed mean of the current distance µ_{currenti} based on this seasonal threshold. The concept drift detection unit may determine whether or not concept drift exists for the point i of the EWM smoothed mean of the current distance µ_{currenti} using the following equation.

$${μ}_{c u r r e n {t}_{i}} > {μ}_{j} + k ∗ {σ}_{j} , i f \text{} i \text{} ∈ s e a s o {n}_{j} .$$

Here, the parameter k is a parameter that designates the number of standard deviations σⱼ from the baseline mean that a current mean can deviate without being considered concept drift. As an example, k may be set to a value of 3, but in cases in which the distance smoothing of Step S560 is applied, a value of less than 3 may be suitable. In the case that the smoothed mean of the current distance µ_{currenti} is greater than the sum of the seasonal time feature baseline mean µⱼ and the product of k and the standard deviation σⱼ (that is, the seasonal threshold), then the concept drift detection unit determines that concept drift exists between the set of current time series data and the set of past time series data for the seasonal time pattern point i. Accordingly, the concept drift detection unit can output a Boolean value that is true if the smoothed mean of the current distance µ_{currenti} satisfies the seasonal threshold and false otherwise.

In embodiments, the concept drift detection unit may be configured to output a concept drift notification indicating the presence or absence of concept drift between the set of current time series data and the set of past time series data for a seasonal time pattern point. In certain embodiments, the concept drift detection unit may be configured to output the concept drift notification in cases that concept drift is determined to exist for a predetermined number of (consecutive) seasonal time pattern points of the smoothed current distance. That is, the smoothed current distance must exceed the seasonal threshold for a certain amount of time (1 or several time steps) or several short-term time windows that belong to the same seasonal time pattern (e.g., for a weekly seasonality, concept drift is detected on the same day of the week for several consecutive weeks) in order to determine that concept drift is present.

In the case that concept drift is detected, the concept drift detection unit may renew the set of past time series data and retrain the baseline model. In the case that no concept drift is detected, the concept drift detection unit may update the set of past time series data and the baseline model with additional data to further improve performance.

In this way, according to the concept drift detection process 500 described with respect to FIG. 5, it is possible to determine the presence or absence of concept drift in seasonal time series data. It should be noted that, unlike existing methods that detect concept drift in stationary data using a single threshold value, in the concept drift detection process 500, a baseline statistic is determined for each of the set of seasonal time pattern points of the baseline distance, thereby making it possible to detect concept drift in seasonal time series data.

Next, an example of the flow of data within the concept drift detection device 250 according to the present disclosure will be described with respect to FIG. 6.

FIG. 6 is a block diagram illustrating an example of the flow of data within the concept drift detection device 250 according to the present disclosure.

First, the data input unit 252 receives a time series data set 230. Here, the time series data set 230 may be transmitted to the data input unit 252 of the concept drift detection device 250 from a client device (for example, the client device 210 illustrated in FIG. 2), or may be acquired from a local or distributed storage device accessible by the concept drift detection device 250. As described herein, the time series data set 230 may include a set of past time series data 602 and a set of current time series data 604.

Next, the baseline model generation unit 254 generates a baseline model 606 based on a subset of the set of past time series data 602. The baseline model 606 may be configured to process a subset of the set of past time series data 602 to generate a set of baseline data. As will be described later, this baseline data is used for the creation of both a baseline distance data and a current distance data for evaluating the presence or absence of concept drift.

Next, the feature extraction unit 256 divides the set of past time series data 602 into a set of past windows, divides the set of current time series data 604 into a set of current windows, and divides the set of baseline data into a set of baseline windows, and subsequently calculates a set of baseline data features 610 from the set of baseline windows, calculates a set of past data features 608 from the set of past windows, and calculates a set of current data features 612 from the set of current windows. Here, calculating the set of baseline data features, the set of past data features, and the set of current data features may include extracting statistical features for each respective window.

Next, the distance calculation unit 258 calculates a baseline distance 614 between a subset of the set of past data features 608 and a subset of the baseline data features 610 that relate to a corresponding time frame, and calculates a current distance 616 between a subset of the set of current data features 612 and a subset of the baseline data features 610 that relate to a corresponding time frame. Here, the baseline distance 614 is a quantitative indication of the relative similarity between the set of past data features 608 and the baseline data features 610. Similarly, the current distance 616 is a quantitative indication of the relative similarity between the set of current data features 612 and the set of baseline data features 610.

Next, the distance smoothing unit 259 performs distance smoothing with respect to the baseline distance 614 and the current distance 616 calculated by the distance calculation unit 258. Here, the distance smoothing unit 259 may perform distance smoothing with respect to each point in the baseline distance 614 and the current distance 616 to calculate a smoothed baseline distance 618 and a smoothed current distance 620.

Next, the concept drift detection unit 260 calculates a seasonal baseline 622 based on the smoothed baseline distance 618. More particularly, the concept drift detection unit 260 may calculate a seasonal baseline for each seasonal time feature by calculating the overall mean and standard deviation for each set of seasonal time pattern points in the baseline distance. Subsequently, the concept drift detection unit 260 may perform concept drift detection 624 based on the seasonal baseline 622 and the smoothed current distance 620.

In embodiments, the concept drift detection unit 260 may output a concept drift notification indicating the presence or absence of concept drift between the set of current time series data 604 and the set of past time series data 602. The concept drift detection unit 260 may transmit this concept drift notification to a client device (for example, the client device 210 illustrated in FIG. 2) of a client who owns or manages the time series data set 230. In certain embodiments, the concept drift detection unit 260 may be configured to output the concept drift notification in cases that concept drift is determined to exist for a predetermined number of (consecutive) seasonal time pattern points of the smoothed current distance 620.

Further, in embodiments, in the case that concept drift is detected, the concept drift detection unit 260 may be configured to update the baseline model 606 based on a second time series data set. This second time series data set may include a time series data set collected subsequent to the past time series data 602 included in the time series data set 230. The baseline model generation unit 254 may use this second time series data set to retrain the ML model that serves as the baseline model 606 in to bring the baseline model 606 into alignment with the characteristics of the present data and minimize or eliminate the detection of concept drift. Similarly, in the case that no concept drift is detected, the concept drift detection unit 260 may be configured to update the past time series data 602 and the baseline model 606 based on newly collected time series data.

According to the embodiments described herein, it is possible to provide a device, method, and system for concept drift detection that is capable of determining the presence or absence of concept drift in seasonal time series data. It should be noted that, unlike existing methods that detect concept drift in stationary data using a single threshold value, in the concept drift detection means according to the present disclosure, a baseline statistic is determined for each of the set of seasonal time pattern points of the baseline distance, thereby making it possible to detect concept drift in seasonal time series data.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A nonexhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

### REFERENCE SIGNS LIST

100... Computer system
102... Processor
104... Memory
106... Memory bus
108... I/O bus
109... Bus IF
110 ... I/O Bus IF
112... Terminal interface
113... Storage interface
114... I/O device interface
115... Network interface
116... User I/O device
117... Storage device
124... Display system
126... Display
130... Network
150... Concept drift detection application
200... Concept drift detection system
210... Client device
220... Data storage device
230... Time series data set
240... Communication network
250... Concept drift detection device
252... Data input unit
254... Baseline model generation unit
256... Feature extraction unit
258... Distance calculation unit
259... Distance smoothing unit
260... Concept drift detection unit

What is claimed is:

1. A concept drift detection device for detecting concept drift in a time series data set, the concept drift detection device comprising:
a data input unit configured to receive a time series data set that includes a set of past time series data relating to a first time period and a set of current time series data relating to a second time period subsequent to the first time period;
a baseline model generation unit configured to generate a baseline model based on a subset of the set of past time series data;
a feature extraction unit configured to:
divide the set of past time series data into a set of past windows, divide the set of current time series data into a set of current windows, and divide a set of baseline data created by the baseline model into a set of baseline windows, and
calculate a set of baseline data features from the set of baseline windows, calculate a set of past data features from the set of past windows, and calculate a set of current data features from the set of current windows;
a distance calculation unit configured to:
calculate a baseline distance between a subset of the set of past data features and a subset of the baseline data features that relate to a corresponding time frame, and
calculate a current distance between a subset of the set of current data features and a subset of the baseline data features that relate to a corresponding time frame; and
a concept drift detection unit configured to:
calculate, based on the baseline distance, a baseline statistic that indicates a reference for determining concept drift, and
determine, based on the baseline statistic and the current distance, presence or absence of concept drift between the set of current time series data and the set of past time series data.

2. The concept drift detection device according to claim 1, further comprising:
a distance smoothing unit configured to use an exponentially weighted moving average technique to smooth the baseline distance and the current distance.

3. The concept drift detection device according to claim 1, wherein:
the baseline model is a trained machine learning model configured to generate, as the baseline data, a set of predicted time series data based on the subset of the set of past time series data.

4. The concept drift detection device according to claim 1, wherein:
the time series data set is seasonal time series data that includes a set of seasonal time patterns that repeat periodically over a defined time period; and
each seasonal time pattern of the set of seasonal time patterns includes a set of seasonal time pattern points corresponding to a set of time features.

5. The concept drift detection device according to claim 4, wherein:
the concept drift detection unit is configured to:
calculate, as the baseline statistic, a seasonal baseline that indicates a reference for determining concept drift for each of the set of seasonal time pattern points of the baseline distance; and
determine that concept drift exists for a first seasonal time pattern point of the current distance in a case that the first seasonal time pattern point of the current distance exceeds a statistical threshold with respect to the seasonal baseline.

6. The concept drift detection device according to claim 5, wherein:
the concept drift detection unit is configured to:
output a concept drift notification in a case that concept drift is determined to exist for a predetermined number of seasonal time pattern points of the current distance.

7. The concept drift detection device according to claim 6, wherein:
the baseline model generation unit is configured to update the baseline model based on a second time series data set in a case that concept drift is determined to exist for a predetermined number of seasonal time pattern points of the current distance.

8. A concept drift detection method for detecting concept drift in a time series data set, the concept drift detection method comprising:
receiving a time series data set that includes a set of past time series data relating to a first time period and a set of current time series data relating to a second time period subsequent to the first time period;
generating a baseline model based on a subset of the set of past time series data;
dividing the set of past time series data into a set of past windows;
dividing the set of current time series data into a set of current windows; and
dividing a set of baseline data created by the baseline model into a set of baseline windows;
calculating a set of baseline data features from the set of baseline windows;
calculating a set of past data features from the set of past windows;
calculating a set of current data features from the set of current windows;
calculating a baseline distance between a subset of the set of past data features and a subset of the baseline data features that relate to a corresponding time frame;
calculating a current distance between a subset of the set of current data features and a subset of the baseline data features that relate to a corresponding time frame;
calculating, based on the baseline distance, a baseline statistic that indicates a reference for determining concept drift; and
determining, based on the baseline statistic and the current distance, presence or absence of concept drift between the set of current time series data and the set of past time series data.

9. A concept drift detection system for detecting concept drift in a time series data set, the concept drift detection system comprising:
a client device;
a data storage device configured to store a time series data set that includes a set of past time series data relating to a first time period and a set of current time series data relating to a second time period subsequent to the first time period; and
a concept drift detection device configured to detect concept drift in the time series data set,
wherein the concept drift detection device further includes:
a data input unit configured to receive the time series data set from the data storage device;
a baseline model generation unit configured to generate a baseline model based on a subset of the set of past time series data;
a feature extraction unit configured to:
divide the set of past time series data into a set of past windows, divide the set of current time series data into a set of current windows, and divide a set of baseline data created by the baseline model into a set of baseline windows, and
calculate a set of baseline data features from the set of baseline windows, calculate a set of past data features from the set of past windows, and calculate a set of current data features from the set of current windows;
a distance calculation unit configured to:
calculate a baseline distance between a subset of the set of past data features and a subset of the baseline data features that relate to a corresponding time frame, and
calculate a current distance between a subset of the set of current data features and a subset of the baseline data features that relate to a corresponding time frame; and
a concept drift detection unit configured to:
calculate, based on the baseline distance, a baseline statistic that indicates a reference for determining concept drift, and
determine, based on the baseline statistic and the current distance, presence or absence of concept drift between the set of current time series data and the set of past time series data, and output a concept drift notification to the client device in a case that concept drift is determined to be present between the set of current time series data and the set of past time series data.
